(19) United States
(12) Patent Application Publication
(10) Pub. No.: US 2020/0215675 A1
(43) Pub. Date: Jul. 9, 2020

(54) Rotary Hammer Drill Adapter

(71) Applicant: Guy Hawkins, Harrah, OK (US)

(72) Inventor: Guy Hawkins, Harrah, OK (US)

(21) Appl. No.: 16/671,359

(22) Filed: Nov. 1, 2019

Related U.S. Application Data
(60) Provisional application No. 62/789,621, filed on Jan. 8, 2019.

(51) Int. Cl. B25D 17/08; B25D 17/02; B25B 21/02; B25B 23/00

(52) U.S. Cl. CPC B25D 17/084; B25D 17/02; B25D 16/00; B25B 23/0035; B25B 21/02

(57) ABSTRACT

A rotary hammer drill adapter. The rotary hammer drill adapter includes an elongated body having a shank end and a bit end. The bit end is disposed on an opposing end of the elongated body relative to the shank end. The shank end has a plurality of grooves disposed on opposing sides of the elongated body and a plurality of sliding keyways disposed on opposing sides of the elongated body. Each of the plurality of sliding keyways is disposed between a pair of the plurality of grooves. The bit end further includes an interface which is adapted to receive complementary bits.

### CROSS REFERENCE TO RELATED APPLICATIONS

This application claims the benefit of U.S. Provisional Application No. 62/789,621 filed on Jan. 8, 2019. The above identified patent application is herein incorporated by reference in its entirety to provide continuity of disclosure.

### BACKGROUND OF THE INVENTION

The present invention relates to rotary hammer drill accessories. More particularly, the present invention provides for a rotary hammer drill adapter that enables a user to utilize a rotary hammer drill for a variety of tasks such as to insert threaded fasteners into concrete, wood, or block surfaces.

Many people use various power tools to complete tasks around the house or on the jobsite. Some surfaces, such as concrete, wood, or block surfaces are hard to work with, especially when drilling and securing fasteners therein. Typically, an individual is required to use two separate power tools; one tool to drill holes and a second tool needed to insert the fasteners. Hammer drills, in particular, are used to add a percussive force when drilling into stone, concrete, brick or mortar. Rotary hammer drills operate like a typical rotary drill, but also include a hammering action which aids in breaking up the material being drilled into as the drill bit works to extend the hole. Rotary hammer drills are more powerful than hammer drills and have separate modes for hammer only, which does not rotate the bit, drill only, which does not include the hammering action, and hammer drill which both rotates the bit and includes the hammering action.

Traditional drills have a three-jaw chuck which open and closed to secure bits therein. These bits include a smooth cylindrical shaft which is secured when the three jaws of the chuck iris tight against the shaft of the bit. Many people have cases filled with bits, such as screw drivers, square socket wrenches, and the like which are used to secure fasteners. Many of these standard bits include a hexagonal shaft that secures in a hexagonal adapter, which in turn secures in the three-jaw chuck. However, these standard bits are not effective when utilized with a rotary hammer drill. When typical bits are used in a hammer drill or a rotary hammer drill, the smooth cylindrical shaft can slide within the chuck and wear away at both the shaft of the drill bit and the chuck of the drill.

Most rotary hammer drills utilize a slotted drive system (“SDS”) style of chuck. The SDS style of chuck is specifically engineered to keep complementary SDS-style drill bit shafts in the chuck via a series of grooves and sliding keyways. The SDS chuck includes bearings that slide within the series of grooves, thus allowing the SDS-style drill bit shaft to move in a hammer-like manner while still being secured in the SDS-style chuck. The sliding keyways keep the bit secured in the chuck while the chuck is rotating. These SDS-style drill bits are constructed to cut holes in the material but are not used to secure fasteners as well.

The present invention substantially diverges in design elements from the known art and consequently it is clear that there is a need in the art for an improvement to existing rotary hammer drill accessories. In this regard the present invention substantially fulfills these needs.

### SUMMARY OF THE INVENTION

In view of the foregoing disadvantages inherent in the known types of rotary hammer drill accessories now present in the prior art, the present invention provides a rotary hammer drill adapter wherein the same can be utilized in concert with a rotary hammer drill for a variety of tasks such as to insert threaded fasteners into concrete, wood, or block surfaces. The present rotary hammer drill adapter comprises an elongated body having a shank end and an opposing bit end. The shank end includes a plurality of grooves disposed opposite each other. The shank end further includes a plurality of sliding keyways disposed opposite each other, wherein each of the plurality of sliding keyways is situated between a pair of the plurality of grooves. In various embodiments, the bit end includes a hexagonal opening. In such embodiments, the bit end receives complementary bits with a hexagonal shaft via the hexagonal opening. In various alternate embodiments, the bit end is a tool such as a screwdriver, a drill, and a square socket wrench driver. The rotary hammer drill adapter allows a user to utilize a rotary hammer drill for a variety of tasks such as to insert threaded fasteners into concrete, wood, or block surfaces.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the rotary hammer drill adapter, with a focus on the bit end.

FIG. 2 shows a perspective view of an embodiment of the rotary hammer drill adapter, with a focus on the shank end.

FIG. 3 shows a perspective view of a series embodiments of the rotary hammer drill adapter.

FIG. 4 shows a cross-sectional view of a chuck with an embodiment of the rotary hammer drill adapter secured therein.

FIG. 5 shows an exploded view of an embodiment of the rotary hammer drill adapter, in use.

### DETAILED DESCRIPTION OF THE INVENTION

Reference is made herein to the attached drawings. Like reference numerals are used throughout the drawings to depict like or similar elements of the rotary hammer drill adapter. For the purposes of presenting a brief and clear description of the present invention, a preferred embodiment will be discussed as used for the rotary hammer drill adapter. The figures are intended for representative purposes only and should not be considered to be limiting in any respect.

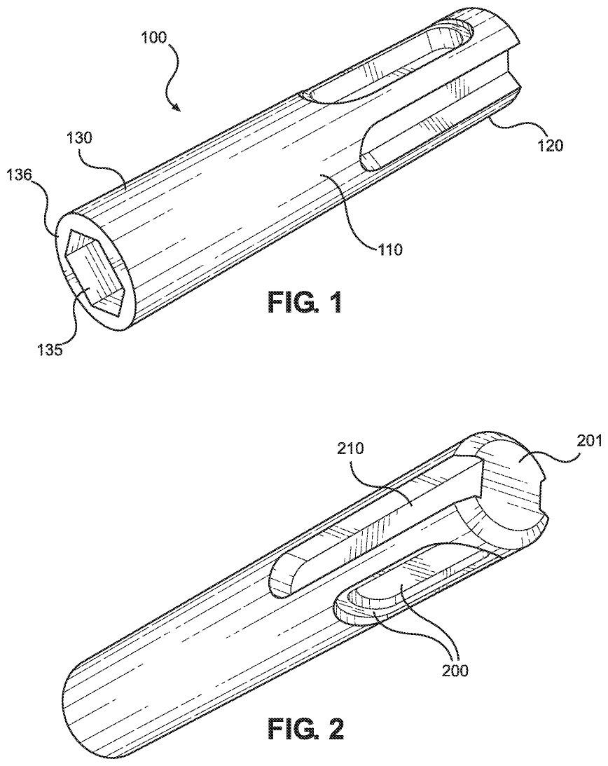

Referring now to FIG. 1, there is shown a perspective view of an embodiment of the rotary hammer drill adapter, with a focus on the bit end. The rotary hammer drill adapter 100 includes an elongated body 110 having a shank end 120 and a bit end 130, wherein the bit end 130 is disposed on an opposing end of the elongated body 110 relative to the shank end 120. In the shown embodiment, the elongated body 110 comprises cylindrical shape. Additionally, in the shown embodiment, the shank end 120 and the bit end 130 comprise a substantially circular cross-section. In other embodiments, the shank end 120 and/or the bit end 130 comprise a substantially square cross-section.

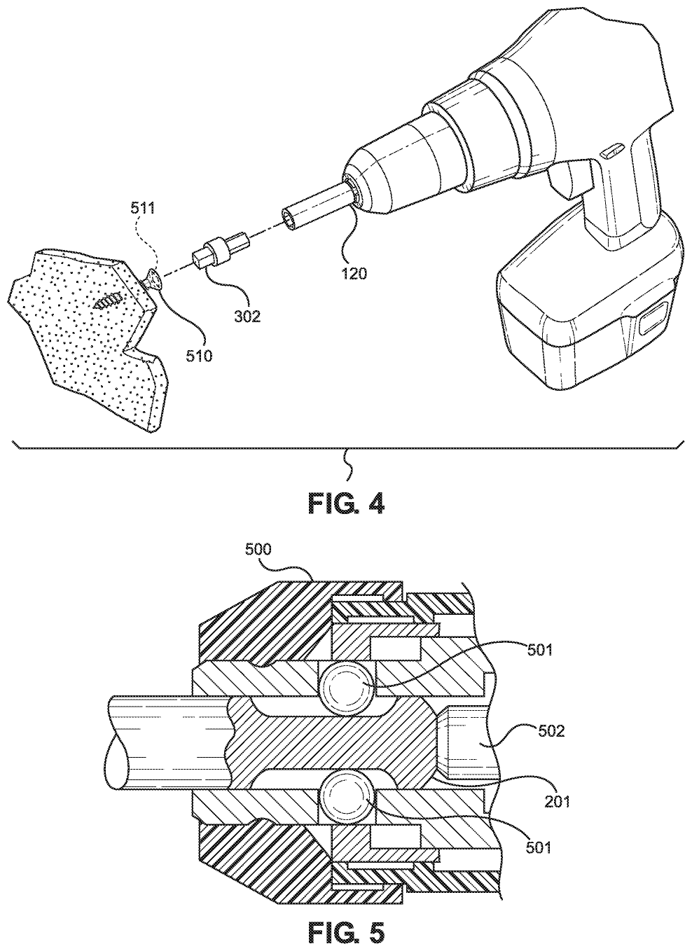

In one embodiment, the bit end 130 further comprises an interface. In the shown embodiment, the interface comprises a hexagonal opening 135 disposed on the distal surface 136 of the bit end 130. In such an embodiment, the hexagonal opening 135 is adapted to receive complementary bits (as seen in FIG. 4). Such complementary bits have a hexagonal shaft of the same diameter as the hexagonal opening 135. In one embodiment, the hexagonal opening is a one quarter inch hexagonal opening 135 and is adapted to receive a one quarter inch hexagonal shaft of a bit.

Referring now to FIG. 2, there is shown a perspective view of an embodiment of the rotary hammer drill adapter, with a focus on the shank end. The shank end 120 comprises a plurality of grooves 200 disposed opposite each other. In the shown embodiment, two grooves 200 are disposed on a cylindrical elongated body 110, a first groove 200 on a top end of the elongated body 110 and the opposing second groove 200 on a bottom end of the elongated body 110. The grooves 200 are disposed along the shank end 120 of the elongated body 110 but do not extend the entire length of the shank end 120. The grooves 200 are encapsulated within the shank end 120 and do not extend the entire distance to the distal end 201 thereof.

The shank end 120 further comprises a plurality of sliding keyways 210. In the shown embodiment, the sliding keyways 210 are disposed opposite each other. Further, in the shown embodiment, the sliding keyways 210 are disposed between a pair of the plurality of grooves 200. The sliding keyways 210 are disposed along the shank end 120 of the elongated body 100 and extend to the distal end 201 thereof. In various embodiments, the shank end 120 of the rotary hammer adapter fits within an SDS chuck, an SIDS Plus chuck, and an SDS Max chuck. In other embodiments, the shank end 120 of the rotary hammer adapter is adapted to be received by, and secured to, a rotary hammer drill and a hammer drill.

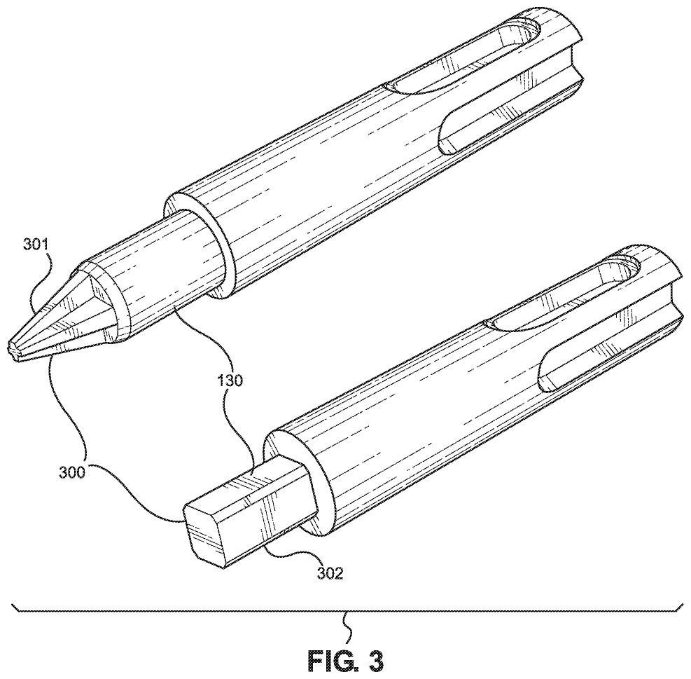

Referring now to FIG. 3, there is shown a perspective view of a series embodiments of the rotary hammer drill adapter. In the shown embodiments, the bit end 130 does not comprise a hexagonal opening, but rather comprises a bit 300 disposed on a distal portion of the bit end 130. In the shown embodiments, the bit 300 comprises a screwdriver 301 and a square socket wrench driver 302. One of ordinary skill in the art will understand that the bit 300 can be any tool commonly secured by a power drill.

Referring now to FIG. 4, there is shown a cross-sectional view of a chuck with an embodiment of the rotary hammer drill adapter secured therein. The shank end 120 of the elongated body comprises a plurality of grooves 200 and sliding keyways 210. A chuck 500 of a rotary hammer drill includes a series of spring-biased ball bearings 501. The plurality of grooves 200 are sized to receive the ball bearings 501. A piston 502 is disposed in the rotary hammer drill which impacts the distal end 201 of the shank. Each impact of the piston 502 onto the distal end 201 of the shank produces a percussive force which is imparted to the rotary hammer drill adapter. The rotary hammer drill adapter slides with each impact but is held in the chuck 500 by the series of spring-biased ball bearings 501. The sliding keyways 210, similarly, are received by complementary protrusions in the chuck 500, such that when the rotary hammer drill adapter rotates, the adapter is held in the chuck 500 via the mating of the sliding keyways 210 to the complementary protrusions in the chuck 500.

Referring now to FIG. 5, there is shown an exploded view of an embodiment of the rotary hammer drill adapter, in use. In the shown embodiment, the rotary hammer drill adapter is secured in the chuck 500 of the rotary hammerdrill. A square socket wrench bit 302 is secured to the adapter via the hexagonal opening on the distal surface of the bit end. The square socket wrench bit 302 is in turn received by a fastener 510 with a complementary square socket opening 511. In this manner, the rotary hammer drill is able to secure the square socket wrench bit 302 and utilize said bit in driving the fastener 510 into the desired surface. In this manner, the rotary hammer drill adapter allows a user to utilize a rotary hammer drill for a variety of tasks such as to insert threaded fasteners into concrete, wood, or block surfaces.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A rotary hammer adapter, comprising:
an elongated body having a shank end and a bit end, wherein the bit end is disposed on an opposing end of the elongated body relative to the shank end;
the shank end comprising a plurality of grooves disposed on opposing sides of the elongated body;
the shank end further comprising a plurality of sliding keyways disposed on opposing sides of the elongated body, wherein each of the plurality of sliding keyways is disposed between a pair of the plurality of grooves;
the bit end further comprising an interface;
the interface adapted to receive complementary bits.

2) The rotary hammer adapter of claim 1, wherein the interface is a hexagonal opening.

3) The rotary hammer adapter of claim 2, wherein the hexagonal opening is a one quarter inch hexagonal opening.

4) The rotary hammer adapter of claim 1, wherein the shank end of the rotary hammer adapter fits within an SDS chuck.

5) The rotary hammer adapter of claim 1, wherein the shank end of the rotary hammer adapter fits within an SDS Plus chuck.

6) The rotary hammer adapter of claim 1, wherein the shank end of the rotary hammer adapter fits within an SDS Max chuck.

7) The rotary hammer adapter of claim 1, wherein the shank end of the rotary hammer is adapted to be received by, and secured to, a rotary hammer drill.

8) The rotary hammer adapter of claim 1, wherein the shank end of the rotary hammer is adapted to be received by, and secured to, a hammer drill.

9) A rotary hammer adapter, comprising:
an elongated body having a shank end and a bit end, wherein the bit end is disposed on an opposing end of the elongated body relative to the shank end;
the shank end comprising a plurality of grooves disposed on opposing sides of the elongated body;
the shank end further comprising a plurality of sliding keyways disposed on opposing sides of the elongated body, wherein each of the plurality of sliding keyways is disposed between a pair of the plurality of grooves;
the bit end further comprising a bit disposed on a distal end thereof.

10) The rotary hammer adapter of claim 9, wherein the shank end of the rotary hammer adapter fits within an SDS chuck.

11) The rotary hammer adapter of claim 9, wherein the shank end of the rotary hammer adapter fits within an SDS Plus chuck.

12) The rotary hammer adapter of claim 9, wherein the shank end of the rotary hammer adapter fits within an SDS Max chuck.

13) The rotary hammer adapter of claim 9, wherein the shank end of the rotary hammer is adapted to be received by, and secured to, a rotary hammer.

14) The rotary hammer adapter of claim 9, wherein the shank end of the rotary hammer is adapted to be received by, and secured to, a hammer drill.

15) The rotary hammer adapter of claim 9, wherein the bit comprises a screwdriver.

16) The rotary hammer adapter of claim 9, wherein the bit comprises a square socket wrench driver.

17) A rotary hammer adapter, comprising:
an elongated body having a shank end and a bit end, wherein the bit end is disposed on an opposing end of the elongated body relative to the shank end;
the shank end comprising two grooves disposed on opposing sides of the elongated body;
the shank end further comprising two sliding keyways disposed on opposing sides of the elongated body, wherein each of the sliding keyways is disposed between the grooves;
the bit end further comprising an interface;
the interface adapted to receive complementary bits.

18) The rotary hammer adapter of claim 17, wherein the interface is a hexagonal opening.

19) The rotary hammer adapter of claim 18, wherein the hexagonal opening is a one quarter inch hexagonal opening.

20) The rotary hammer adapter of claim 17, wherein the shank end of the rotary hammer adapter fits within an SDS chuck.
